(19) United States
(12) Patent Application Publication
(10) Pub. No.: US 2008/0004999 A1
(43) Pub. Date: Jan. 3, 2008

(54) High-security time-and-attendance data collection system

(76) Inventor: Pamela Ann Miller, Johnson City, TN (US)

Correspondence Address: SUSAN F. JOHNSTON;ATTORNEY AT LAW, PO Box 4449, JOHNSON CITY, TN, 37602, US

(21) Appl. No.: 11/478,969

(22) Filed: Jun. 28, 2006

(51) Int. Cl. G07C 1/10

(52) U.S. Cl. 705/32

(57) ABSTRACT

The present invention comprises a system including a server and a remote computing device such as an electronic timeclock integrated with geographic positioning technology and user identification technology, wherein the server and the remote computing device are in operable communication with each other. The system includes programming for authenticating the identity of the data collected by the remote device via the positioning and identification determinations and for processing authenticated time and attendance information differently than unauthenticated time and attendance information.

### CROSS REFERENCES TO RELATED APPLICATIONS

none.

### TECHNICAL FIELD

The present invention relates generally to the field of remote data collection and, more particularly, to a system and method for remote collection of employee time and attendance data.

### BACKGROUND

Employers of remote employees have long struggled with effectively tracking the location and work performance of their employees for many reasons. It is important to verify a remote employee's location for the purpose of verifying his time and attendance at assigned job posts throughout the day. Time and attendance data is used in processing payroll, job-costing for financial reports, human resource scheduling, billing, fraud prevention, and other such business purposes. Time and attendance data is also useful for integration into job data related programs for purposes such as for verifying the identity of a specialist performing a sensitive job. The verification of the identity of a remote employee performing a job and transmitting job data back to a server can affect the credibility and dependability of the job data. For security and law enforcement applications, for example, it would be useful for the employer to be able to track employees in a secure way so that human resources can be dynamically reallocated in times of crisis management.

Existing personal tracking device systems are designed for transmitting portable device location information across a wireless network to a monitoring system server. However, such tracking systems are not sufficiently reliable for time and attendance based systems because the location information gathered in existing systems corresponds to the location of the portable device, not to the location of a particular person.

In light of the above, it is the object of the present invention to provide a more secure system for tracking and gathering time and attendance information of a remote employee using a portable computing device in communication with a server programmed to process time and attendance data.

### BRIEF SUMMARY OF THE INVENTION

The present invention comprises a system including a server and a remote computing device such as an electronic timeclock integrated with geographic positioning technology and user identification technology, wherein the server and the remote computing device are in operable communication with each other. The system includes programming for authenticating the identity of the data collected by the remote device via the positioning and identification determinations and for processing authenticated time and attendance information differently than unauthenticated time and attendance information.

### DETAILED DESCRIPTION OF THE INVENTION

The present invention is a high-security system for collecting and processing time and attendance information pertaining to a particular person. In the present system, the person or employee being tracked is authorized to operate a remote computing device that is remote from a server programmed for processing time and attendance data. Thus, the employee is referred to hereinafter as the “authorized operator” of the remote computing device. In this system, the time and attendance information entered into the remote computing device is verified to actually be data pertaining to the authorized operator by authenticating the identity of the authorized operator by requiring comparison of a personal identifying parameter of the operator against a known, valid identifier of the authorized operator. This identity comparison and authentication can be conducted at the server level, at the remote computing device level, or at both levels. Additionally, the time and attendance information entered into the remote computing device is verified by a geographic positioning unit included as part of the remote computing device. Further, the operator identification component and the operator positioning components of this system are in communication with a clock adapted to time-stamp the identity measurement and location determination of the operator.

The present system is particularly beneficial in high-security applications because the server is programmed to process authenticated time and attendance data differently from unauthenticated time and attendance data. Thus, as an example, a security guard monitoring system incorporating the present time and attendance system may be adapted to alarm the system administrator when unauthenticated time and attendance data is produced from the system. As another example, a payroll monitoring system incorporating the system of the present invention may be adapted to automatically require further proof of employee job post attendance before paying an employee for unauthenticated work time:

The preferred embodiment of the present system further includes a schedule for coordinating position location measurements with operator identification measurements. For example, the system may be programmed so that a location measurement is automatically performed each time an operator enters his identification data into the portable computing device and then at other times according to an algorithm. A coordination schedule can be programmed into the server processor or in the device processor or in both locations.

The preferred embodiment of the present system further includes a security re-verification schedule programmed at the server level and/or the device level for requiring the remote device to collect an updated position and/or identification measurement.

The present system includes a server and a remote computing device in communication with each other in a wired or wireless server-client relationship, as is well known in the art. The server may be any computing device that can accept and respond to TCP/IP or any network protocol.

The remote computing device of the present system may be a computer on a wired or wireless server network such as a personal computer since the authenticated product of the present system provides value to such immobile networks, especially in large employer settings such as hospitals and factories. The remote computing device must be capable of communicating with the server via TCP/IP or any network protocol. The remote computing device of the present invention is preferably portable, including laptop and notebook computers, with handheld computing devices being the most preferred type of remote device.

The remote computing device includes an electronic clock component which tracks and calculates the date and time of various activities of the remote computing device. Such clocks are typically based on crystal movement. An electronic timeclock is an existing device that has a clock component and a processor. Thus, in practice, the remote computing device of the present system is most practically made by integrating additional components into an electronic timeclock structure and programming the timeclock processor to carryout the functions required of the remote computing device of the present invention.

The remote computing device includes an operator identification component adapted for measuring an identifying parameter of an operator. Examples of useful operator identification components include elaborate biometric readers including fingerprint scanners, retinal scanners, voice recognition, and other such sensors. However, simpler user identification means such as user code input keyboards, barcode scanners, and cameras are also examples of useful identification components. These technologies can usefully be combined for “smart card” security.

The remote computing device includes a positioning component adapted for determining data indicative of its geographic location. Examples of useful positioning components include any form of global positioning satellite technology (GPS), aGPS, triangulation, or geographic data (or any other suitable location data) stored in a GPS/Geo Map component.

Both the remote computing device and the server comprise a processor. A valid identifier of an authorized operator using the same identification technology as the operator identification component is preprogrammed into the processor at the server level or at the remote device level, or at both places. The processor location where the valid identifier is stored is programmed for comparing the known identifier against a new identification data reading to provide an authentication result indicating whether there was a “match”.

The remote computing device of the present invention can include additional components for collecting job data. For example, the device can be adapted for receiving data collection media such cameras, barcode scanners, scales, calipers, pH meters, micrometers, thermometers, keyboards for text entry, light meters, voice recorders, and such. The collection of any such type of data is accompanied by the GPS-based time and location stamp, and preferably the user identification stamp. It should be appreciated that the present device will provide improved security for a wide variety of sensitive mobile data collection activities. The remote computing device may include integrated components as well as modular components for “plug-in” adaptability according to the job application.

The present system is useful in any time and attendance application. The system is particularly useful for tracking law enforcement and security guard personnel since the verified location and identification of such employees is critical. In using the present system, the system administrator or dispatcher not only knows where the remote device is located, but can also know with certainty where the authorized operator of the device is located to avoid processing of false data from unauthorized users.

Another application in which the present system is particularly beneficial is in the integration of the present system into a medical records system for patient care. In such an embodiment of the present system, the operator identification component is used to identify a patient and the patient's valid identifier is programmed into the system similarly to the way that the authorized operator's valid identifier is used in the system. In this embodiment, authenticated data can be collected representing the identification of the health care provider, the identification of the patient, the medical testing location, the date and time of the testing, and the test results.

Other uses of the system of the present invention will become apparent.

1. A high-security system for collecting and processing time and attendance information pertaining to an authorized operator of a portable computing device, said system comprising:
a server programmed for processing time and attendance data of the authorized operator, wherein said server is programmed to process authenticated time and attendance data differently from unauthenticated time and attendance data; and
a portable computing device operable to communicate with said server, said portable computing device including
a) an operator identification component adapted for measuring an identifying parameter of an operator to provide identification data, said operator identification component in communication with a clock adapted for time-stamping said identification data to provide time-stamped identification data;
b) a positioning component adapted for determining data indicative of its geographic location to provide location data, said positioning component in communication with a clock adapted for time-stamping said location to provide time-stamped location data,
c) a device processor in communication with said operator identification component and said positioning component, said device processor programmed with a valid identifier of the authorized operator, said device processor adapted for comparing said identification data against said valid identifier, said device processor further adapted for providing a report of authenticated time and attendance data and unauthenticated time and attendance data for transmittal to said server based upon said comparing step.

2. The system according to claim 1 wherein said device processor is programmed with a coordination schedule for coordinating said location determining step with said identification measuring step, said device processor adapted for activating at least one of said operator identification component and said positioning component according to said coordination schedule.

3. The system according to claim 1 wherein said device processor is programmed with a security re-verification schedule, said device processor adapted for activating at least one of said operator identification component and said positioning component according to said security re-verification schedule.

4. The system according to claim 1 wherein said server is programmed with a security re-verification schedule, said server adapted for activating at least one of said operator identification component and said positioning component according to said security re-verification schedule.

5. The system according to claim 4 wherein said device further includes a communications component adapted for receiving information from the server, said server programmed for processing time and attendance data for a human resource allocation system, said server adapted for transmitting location re-assignment instruction to the operator by way of said communications component.

6. The system according to claim 1 wherein said device further comprises a job data collection component operable by the operator for collecting job data, said data collection component in communication with said clock and said device processor so that said report of authenticated time and attendance data and unauthenticated time and attendance data includes said job data.

7. The system according to claim 6 wherein said operator identification component is further adapted for measuring an identifying parameter of a patient to provide patient identification data, further wherein said device processor is programmed with a valid patient identifier, said device processor adapted for comparing said identification data against said valid identifier.

8. A high-security system for collecting and processing time and attendance information pertaining to an authorized operator of a portable computing device, said system comprising:
a server programmed for processing time and attendance data of the authorized operator, wherein said server is programmed with a valid identifier of the authorized operator, wherein said server is adapted for comparing identification data against said valid identifier for authenticating time and attendance data, wherein said server is programmed to process authenticated time and attendance data differently from unauthenticated time and attendance data; and
a portable computing device operable to communicate with said server, said portable computing device including
a) an operator identification component adapted for measuring an identifying parameter of an operator to provide identification data, said operator identification component in communication with a clock adapted for time-stamping said identification data to provide time-stamped identification data,
b) a positioning component adapted for determining data indicative of its geographic location to provide location data, said positioning component in communication with a clock adapted for time-stamping said location to provide time-stamped location data,
c) a device processor in communication with said operator identification component and said positioning component, said portable computing device processor adapted to transmit data received from said components to said server.

9. The system according to claim 8 wherein said server is programmed with a coordination schedule for coordinating said location determining step with said identification measuring step, said server adapted for activating at least one of said operator identification component and said positioning component according to said coordination schedule.

10. The system according to claim 8 wherein said server is programmed with a security re-verification schedule, said server adapted for activating at least one of said operator identification component and said positioning component according to said security re-verification schedule.

11. The system according to claim 8 wherein said device further includes a communications component adapted for receiving information from the server, said server programmed for processing time and attendance data for a human resource allocation system, said server adapted for transmitting location re-assignment instruction to the operator by way of said communications component.

12. The system according to claim 8 wherein said device further comprises a job data collection component operable by the operator for collecting job data, said data collection component in communication with said clock and said device processor so that said report of authenticated time and attendance data and unauthenticated time and attendance data includes said job data.

13. The system according to claim 12 wherein said operator identification component is further adapted for measuring an identifying parameter of a patient to provide patient identification data, further wherein said device processor is programmed with a valid patient identifier, said device processor adapted for comparing said identification data against said valid identifier.

14. A high-security system for collecting and processing time and attendance information pertaining to an authorized operator of a portable computing device, said system comprising:
a server programmed for processing time and attendance data of the authorized operator, wherein said server is programmed with a valid identifier of the authorized operator, wherein said server is adapted for comparing identification data against said valid identifier for authenticating time and attendance data, wherein said server is programmed to process authenticated time and attendance data differently from unauthenticated time and attendance data; and
a portable computing device operable to communicate with said server, said portable computing device including
a) an operator identification component adapted for measuring an identifying parameter of an operator to provide identification data, said operator identification component in communication with a clock adapted for time-stamping said identification data to provide time-stamped identification data,
b) a positioning component adapted for determining data indicative of its geographic location to provide location data, said positioning component in communication with a clock adapted for time-stamping said location to provide time-stamped location data,
c) a device processor in communication with said operator identification component and said positioning component, said device processor programmed with said valid identifier, said device processor adapted for comparing said identification data against said valid identifier, said device processor further adapted for providing a report of authenticated time and attendance data and unauthenticated time and attendance data for transmittal to said server based upon said comparing step.

15. A method for collecting and processing time and attendance information pertaining to an authorized operator, said method comprising:
a) programming a server for processing time and attendance data of the authorized portable computing device operator according to whether the time and attendance data is authenticatable or unauthenticatable by the server;
b) equipping said authorized operator with an electronic timeclock adapted for verifying said authorized operator's identity and determining its geographic location, wherein said electronic timeclock is in communication with said server to transmit an activity record to said server;
c) programming said server with a valid identifier of the authorized operator, wherein said valid identifier is useful for authenticating said authorized operator's identity.
